(19) United States
(12) Patent Application Publication
(10) Pub. No.: US 2026/0341559 A1
(43) Pub. Date: Oct. 29, 2026

(54) CERAMIC ELECTRONIC DEVICE

(71) Applicant: TDK Corporation, Tokyo (JP)

(72) Inventors: Kazuki FUKASAWA, Tokyo (JP); Tomohisa AZUMA, Tokyo (JP); Kazuhiko ITOH, Tokyo (JP); Masayuki UCHIDA, Tokyo (JP)

(73) Assignee: TDK Corporation, Tokyo (JP)

(21) Appl. No.: 19/565,091

(22) Filed: Mar. 12, 2026

(30) Foreign Application Priority Data
Mar. 14, 2025 (JP) 2025-041704

(51) Int. Cl. H01C 7/12; H01C 7/10

(52) U.S. Cl. CPC H01C 7/12; H01C 7/1006

(57) ABSTRACT

A ceramic electronic device includes an inner ceramic layer; at least a pair of internal electrode layers disposed so as to sandwich the inner ceramic layer between the pair of internal electrode layers; and intermediate layers provided between the inner ceramic layer and the internal electrode layers. The intermediate layers contain, as a main component, at least one element selected from the group consisting of praseodymium and bismuth.

Priority is claimed on Japanese Patent Application No. 2025-041704, filed on Mar. 14, 2025, the entire content of which is incorporated herein by reference.

### BACKGROUND OF THE INVENTION

The present invention relates to a ceramic electronic device including, for example, an inner ceramic layer and an internal electrode layer.

### DESCRIPTION OF THE RELATED ART

In recent years, miniaturization has been progressing in home appliances and in-vehicle materials, and there has also been a demand for miniaturization of varistors that are components thereof. Therefore, a multilayer chip varistor has been proposed in which an inner ceramic layer (varistor layer, interlayer voltage nonlinear resistive layer) and internal electrode layers are laminated.

In a multilayer chip varistor, there has been a demand for improvement in resistance against electrostatic discharge (ESD). A multilayer chip varistor having improved ESD resistance, in other words, a multilayer chip varistor having good ESD resistance characteristics is used as an effective protection element for electronic circuits.

However, in a multilayer chip varistor, there has been a problem that components in the internal electrode layers diffuse into the inner ceramic layer due to heat treatment such as firing, thereby resulting in degradation of ESD resistance. Specifically, the inner ceramic layer locally containing a large amount of components constituting the internal electrode layers is formed in the vicinity of the internal electrode layers, and therefore, variations in varistor voltage tend to occur when ESD is repeatedly applied. Hereinafter, the degradation rate of the varistor voltage before and after the application of ESD is referred to as an ESD resistance degradation rate.

For example, Patent Document 1 (JP 4915153 B2) discloses that the diffusion of Ag can be suppressed by adding various additives to a ceramic layer. However, since measures against diffusion of Ag into the ceramic layer in the vicinity of an internal electrode layer are insufficient, the diffusion is promoted in situations where Ag is likely to diffuse, such as in a high-humidity environment, and there is a risk that the ESD resistance is degraded.

In addition, Patent Document 2 (WO 2020/213320 A) discloses that Au or Pt are caused to act to reduce oxidized Ag by adding Au or Pt to internal electrode layers, and as a result, Ag can be prevented from diffusing into a varistor layer; however, since a portion of electrode components diffuses into the varistor layer once the electrode components are oxidized, the effect is limited and insufficient to suppress degradation of ESD resistance.

As described in Patent Document 3 (JP 6708655 B2), there is a method in which insulation is obtained by pre-incorporating components of internal electrode layers, which tend to diffuse, into the starting composition of a varistor layer; however, since the amount of diffusion varies depending on the number of internal electrode layers, fine adjustment of the composition is required, thereby making manufacturing more difficult; furthermore, since the ceramic layer contains the components of the internal electrode layers, the ESD resistance tends to degrade.

As described in Patent Document 4 (JP H4-32213 A), there is a method in which diffusion is prevented by providing a barrier layer between an internal electrode layer and a ceramic layer; however, when the barrier layer is formed of the materials as disclosed, the ESD resistance of the barrier layer is low, and as a result, the ESD resistance of the entire product tends to degrade.

As described in Patent Document 5 (JP 3924563 B2), there is a method in which the ESD resistance is improved by making the Pr concentration in a varistor layer uniform; however, similarly to Patent Document 2, Ag cannot be prevented from diffusing into the varistor layer due to heat treatment such as firing, and the ESD resistance tends to degrade.

### SUMMARY OF THE INVENTION

The present invention has been made in view of such circumstances, and an object of the present invention is to provide a ceramic electronic device exhibiting a low ESD resistance degradation rate.

To achieve the above-described object, a ceramic electronic device according to the present invention includes an inner ceramic layer; at least a pair of internal electrode layers disposed so as to sandwich the inner ceramic layer between the pair of internal electrode layers; and intermediate layers provided between the inner ceramic layer and the internal electrode layers. The intermediate layers contain, as a main component, at least one element selected from the group consisting of praseodymium (Pr) and bismuth (Bi).

According to the present invention, a ceramic electronic device exhibiting a low ESD resistance degradation rate can be provided.

The intermediate layers further contain zinc as a main component. The main components of the intermediate layers are components, each component in the intermediate layers having a total amount of preferably 10 at % or more when a total amount of elements other than oxygen, carbon, and nitrogen contained in the intermediate layers is taken as 100 at %. When the total amount of elements other than oxygen, carbon, and nitrogen contained in the intermediate layers is taken as 100 at %, a total amount of at least one element selected from the group consisting of praseodymium and bismuth contained in the intermediate layers is preferably 10 at % or more.

In a predetermined cross-sectional plane (cut surface) parallel to a lamination direction of the inner ceramic layer and the internal electrode layers, preferably, a coverage ratio of the intermediate layers is 0.02 or more and 0.92 or less. The coverage ratio of the intermediate layers is represented by Lm/(L×N), where L is a length, in a layer direction, of a region in which the internal electrode layers face each other, Lm is a sum of lengths, in the layer direction, of regions in which the internal electrode layers and the intermediate layers are in contact with each other within the region in which the internal electrode layers face each other, and N is the number of surfaces of the internal electrode layers with which the intermediate layers are in contact at at least one location.

A ceramic electronic device exhibiting a lower delamination rate can be obtained by setting the coverage ratio of the intermediate layers to 0.02 or more and 0.92 or less. In addition, when the delamination rate is lower, the diffusion rate of components of the internal electrode layers tend to be lower, and the ESD resistance degradation rate also tends to be lower.

In a cross-sectional plane parallel to a lamination direction of the inner ceramic layer and the internal electrode layers, preferably, an average value of a thickness of the intermediate layer is 0.10 μm or more and 5.00 μm or less.

Preferably, the intermediate layers further contain cobalt (Co).

According to the present invention, a ceramic electronic device exhibiting a lower ESD resistance degradation rate can be provided.

Preferably, the intermediate layers further contain chromium (Cr).

Preferably, the intermediate layers further contain calcium (Ca).

Preferably, the internal electrode layers contain at least one element selected from the group consisting of silver (Ag) and palladium (Pd).

The ceramic electronic device according to the present invention is not particularly limited; however, examples thereof include a multilayer chip varistor, a disk varistor, a varistor composite element, and the like.

### BRIEF DESCRIPTION OF THE DRAWINGS

FIG. 1 is a cross-sectional view of a multilayer chip varistor according to one embodiment of the present invention; and

FIG. 2 is an enlarged view of portion II in FIG. 1.

### DETAILED DESCRIPTION OF THE PREFERRED EMBODIMENTS

Hereinafter, the present invention will be described based on an embodiment shown in the drawings.

### Multilayer Chip Varistor

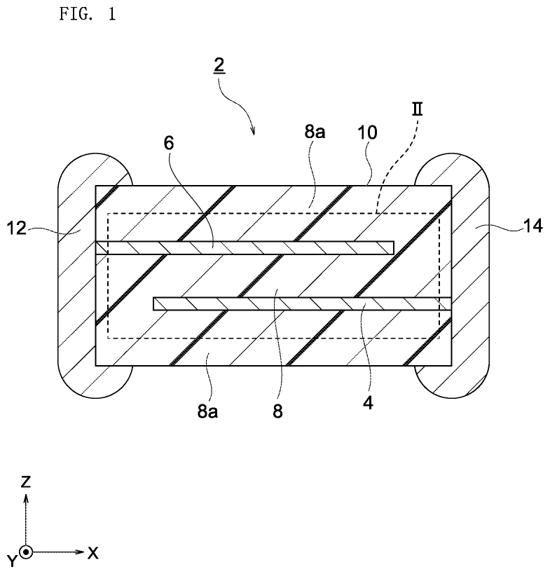

A varistor is an element, the resistance value of which changes depending on the applied voltage. As shown in FIG. 1, a multilayer chip varistor 2 as one example of a ceramic electronic device includes an element body 10 having a configuration in which internal electrode layers 4 and 6, an inner ceramic layer 8, and outer protective layers 8a substantially parallel to an X-Y plane are laminated in a Z-axis direction.

In the element body 10, the outer protective layers 8a are disposed at both end portions of the internal electrode layers 4 and 6 and the inner ceramic layer 8 in the Z-axis direction (lamination direction), and the outer protective layers 8a protect the inside of the element body 10.

A pair of external terminal electrodes 12 and 14 electrically connected to the internal electrode layers 4 and 6 disposed inside the element body 10 are formed at both end portions of the element body 10 in an X-axis direction (layer direction), thereby forming a circuit.

The shape of the element body 10 is not particularly limited, but is typically a rectangular parallelepiped. In addition, the dimensions thereof are not particularly limited and may be set to appropriate dimensions depending on the application, but are typically about 0.6 mm to 5.6 mm in length, 0.3 mm to 5.0 mm in width, and 0.3 mm to 1.9 mm in thickness.

In the present embodiment, the X-axis, the Y-axis, and the Z-axis are perpendicular to each other. In addition, the “lamination direction” refers to the Z-axis direction, and the “layer direction” refers to a direction parallel to the X-axis and/or Y-axis. Furthermore, “inside” refers to a side closer to the center of the multilayer chip varistor 2, and “outside” refers to a side farther from the center of the multilayer chip varistor 2.

### Internal Electrode Layer

The conductive material contained in the internal electrode layers 4 and 6 preferably contains at least one element selected from the group consisting of silver (Ag) and palladium (Pd), and may be composed of an Ag—Pd alloy. When the conductive material contained in the internal electrode layers 4 and 6 is Ag and/or Pd, the diffusion suppression effect of intermediate layers 24 and 26 is more exhibited. In other words, when the conductive material contained in the internal electrode layers 4 and 6 is Ag and/or Pd, the effect of suppressing diffusion of Ag and/or Pd constituting the internal electrode layers 4 and 6 into the inner ceramic layer 8 is more exhibited by the intermediate layers 24 and 26.

The amount of Pd in the Ag—Pd alloy is preferably 95 parts by mass or more when the amount of the Ag—Pd alloy is taken as 100 parts by mass. The thickness of the internal electrode layers 4 and 6 may be appropriately determined depending on the application, but is typically about 0.5 μm to 5 μm.

### External Terminal Electrode

The conductive material contained in the external terminal electrodes 12 and 14 is not particularly limited, but typically Ag, an Ag—Pd alloy, or the like is used. The thickness of the external terminal electrodes 12 and 14 may be appropriately determined depending on the application, but is typically about 10 μm to 50 μm.

### Inner Ceramic Layer

The inner ceramic layer 8 is also referred to as an interlayer voltage nonlinear resistive layer 8 or a varistor layer 8. The inner ceramic layer 8 contains zinc oxide (ZnO) as a main component and, as subcomponents, metals in elemental form such as cobalt (Co), rare earth metal elements, Group IIIb elements, silicon (Si), chromium (Cr), molybdenum (Mo), bismuth (Bi), antimony (Sb), alkali metal elements, and/or alkaline earth metal elements, or oxides thereof. The inner ceramic layer 8 may contain silver (Ag) to an extent that does not adversely affect the characteristics.

Examples of rare earth metal elements that are subcomponents of the inner ceramic layer 8 include praseodymium (Pr).

Examples of Group IIIb elements that are subcomponents of the inner ceramic layer 8 include boron (B), aluminum (Al), gallium (Ga), and indium (In).

Examples of alkali metal elements that are subcomponents of the inner ceramic layer 8 include lithium (Li), sodium (Na), potassium (K), rubidium (Rb), and cesium (Cs).

Examples of alkaline earth metal elements that are subcomponents of the inner ceramic layer 8 include magnesium (Mg), calcium (Ca), strontium (Sr), and barium (Ba).

The amount of ZnO in the inner ceramic layer 8 is not particularly limited, but is 99.8 parts by mass to 69.0 parts by mass when the total amount of the materials constituting the inner ceramic layer 8 is taken as 100 parts by mass. The rare earth metal elements act as substances that impart varistor characteristics. When the amount of elements other than oxygen, carbon, and nitrogen contained in the inner ceramic layer 8 is taken as 100 at %, the amount of rare earth metal elements in the inner ceramic layer 8 is set to, for example, about 0.01 at % to 10 at %.

Various conditions such as the thickness and the number of layers of the inner ceramic layer 8 may be appropriately determined depending on the purpose or application. In the present embodiment, the thickness of the inner ceramic layer 8 is, for example, about 5 μm to 100 μm, and the number of layers is, for example, about 1 to 50.

### Outer Protective Layer

In the present embodiment, the “inner ceramic layer 8” and the “outer protective layers 8a” may be collectively referred to as a “ceramic layer”.

The material of the outer protective layer 8a may be the same as or different from the material of the inner ceramic layer 8.

The thickness of the outer protective layer 8a is, for example, about 100 μm to 500 μm.

### Intermediate Layer

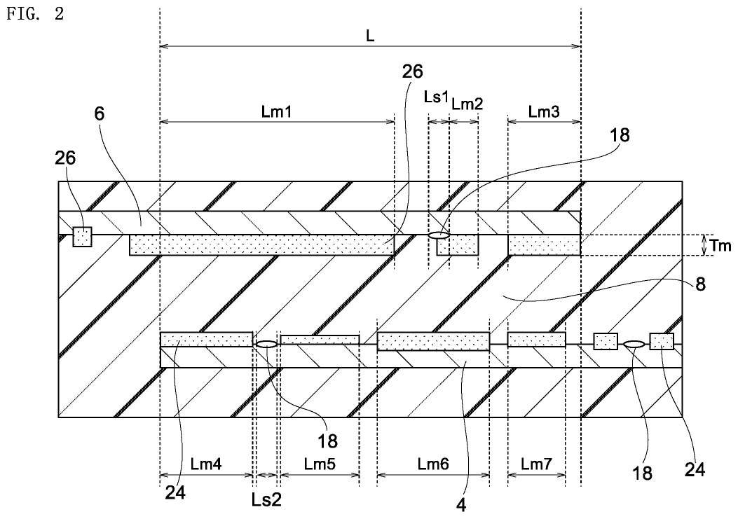

In the present embodiment, as shown in FIG. 2, the intermediate layer 24 (26) is provided between the inner ceramic layer 8 and the internal electrode layer 4 (6). The intermediate layer 24 (26) is in contact with the internal electrode layer 4 (6), and preferably, the intermediate layer 24 (26) is in intermittent contact with the internal electrode layer 4 (6) in the layer direction. In addition, the intermediate layer 24 (26) is also in contact with the inner ceramic layer 8, and preferably, the intermediate layer 24 (26) is in intermittent contact with the inner ceramic layer 8 in the layer direction.

The intermediate layer 24 (26) includes not only those formed by patterning, but also those that exist non-uniformly due to segregation at the interface between the internal electrode layer 4 (6) and the inner ceramic layer 8.

The intermediate layers 24 and 26 contain, as a main component, at least one element selected from the group consisting of Pr and Bi. In addition, the intermediate layers 24 and 26 may contain Zn as a main component in addition to the at least one selected from the group consisting of Pr and Bi. Here, the main components of the intermediate layers 24 and 26 are components in which the total amount of each component in the intermediate layers 24 and 26 is preferably 10 at % or more when the amount of elements other than oxygen, carbon, and nitrogen contained in the intermediate layers 24 and 26 is taken as 100 at %.

When the total amount of elements other than oxygen, carbon, and nitrogen contained in the intermediate layers 24 and 26 is taken as 100 at %, the total amount of at least one element selected from the group consisting of praseodymium and bismuth contained in the intermediate layers 24 and 26 is preferably 10 at % or more, and more preferably 12 at % to 96 at %.

When the total amount of elements other than oxygen, carbon, and nitrogen contained in the intermediate layers 24 and 26 is taken as 100 at %, Zn is contained in the intermediate layers 24 and 26 preferably in an amount of 0.1 at % to 90 at %, and more preferably 0.6 at % to 88 at %.

The intermediate layers 24 and 26 further contain Co. When the amount of elements other than oxygen, carbon, and nitrogen contained in the intermediate layers 24 and 26 is taken as 100 at %, Co is contained in the intermediate layers 24 and 26 preferably 1 at % or more, and more preferably 1 at % to 18 at %. The ESD resistance degradation rate can be further reduced by having Co contained in addition to Pr and/or Bi in the intermediate layers 24 and 26.

The intermediate layers 24 and 26 further contain Cr. When the amount of elements other than oxygen, carbon, and nitrogen contained in the intermediate layers 24 and 26 is taken as 100 at %, Cris contained in the intermediate layers 24 and 26 preferably 1 at % or more, and more preferably 1 at % to 24 at %. The ESD resistance degradation rate can be further reduced by having Co and Cr contained in addition to Pr and/or Bi in the intermediate layers 24 and 26.

The intermediate layers 24 and 26 further contain Ca. When the amount of elements other than oxygen, carbon, and nitrogen contained in the intermediate layers 24 and 26 is taken as 100 parts by mole, Ca is contained in the intermediate layers 24 and 26 preferably in an amount of 1 at % or more, and more preferably 1 at % to 39 at %. The ESD resistance degradation rate can be particularly reduced by having Co, Cr, and Ca contained in addition to Pr and/or Bi in the intermediate layers 24 and 26.

In the present embodiment, in a predetermined cross-sectional plane parallel to the lamination direction of the inner ceramic layer 8 and the internal electrode layers 4 and 6 as shown in FIG. 2, the coverage ratio of the intermediate layers 24 and 26 is preferably 0.02 or more and 0.92 or less, and more preferably 0.10 more and 0.80 or less.

In a case in which the coverage ratio of the intermediate layers 24 and 26 is 0.02 or more, the diffusion suppression effect is higher and the ESD resistance degradation rate is further reduced compared to a case in which the coverage ratio of the intermediate layers 24 and 26 is less than 0.02.

In a case in which the coverage ratio of the intermediate layers 24 and 26 is 0.92 or less, the adhesion between the internal electrode layers 4 and 6 and the inner ceramic layer 8 is favorable and the delamination rate is reduced compared to a case in which the coverage ratio of the intermediate layers 24 and 26 exceeds 0.92. Since a location where delamination does not occur is electrically active, the load on the electrically active location is reduced when the delamination rate is low, and therefore, the ESD resistance degradation rate tends to further decrease.

The coverage ratio of the intermediate layers 24 and 26 is represented by Lm/(L×N) in a predetermined cross-sectional plane parallel to the lamination direction of the inner ceramic layer 8 and the internal electrode layers 4 and 6.

Here, the predetermined cross-sectional plane is a cross-sectional plane including, as shown in FIG. 2, at least a pair of the internal electrode layers 4 and 6, the inner ceramic layer 8 sandwiched between the pair of internal electrode layers 4 and 6, and a total of two outer protective layers 8a disposed outside the pair of internal electrode layers 4 and 6. Therefore, in the predetermined cross-sectional plane, in the lamination direction, the entirety of the pair of internal electrode layers 4 and 6 is shown, the entirety of the inner ceramic layer 8 is shown, and at least a part of the outer protective layers 8a is shown.

L is the length, in the layer direction (parallel to an X-Y plane), of a region in which the internal electrode layers 4 and 6 face each other.

In addition, Lm is the sum of the lengths, in the layer direction, of regions in which the internal electrode layer 4 (6) and the intermediate layer 24 (26) are in contact with each other within the region in which the internal electrode layers 4 (6) face each other. For example, in FIG. 2, since the lengths, in the layer direction, of the regions in which the internal electrode layer 4 (6) and the intermediate layer 24 (26) are in contact with each other within the region in which the pair of internal electrode layers 4 and 6 face each other are shown as “Lm1”, “Lm2”, “Lm3”, “Lm4”, “Lm5”, “Lm6”, and “Lm7” in FIG. 2, the equation Lm=Lm1+Lm2+Lm3+Lm4+Lm5+Lm6+Lm7 is established. In addition, when a void 18 is formed between the internal electrode layer 4 (6) and the intermediate layer 24 (26), the length, in the layer direction, of a region in which the void 18 is formed is not included in Lm.

N is the number of surfaces of the internal electrode layer 4 (6) with which the intermediate layer 24 (26) is in contact at at least one location. For example, in the cross-sectional plane shown in FIG. 2, only the inner surface of the internal electrode layer 4 (6) is in contact with the intermediate layer 24 (26), and the outer surface of the internal electrode layer 4 (6) is not in contact with the intermediate layer 24 (26). Therefore, N is “2” in the cross-sectional plane shown in FIG. 2.

In the present embodiment, the coverage ratio of the intermediate layers 24 and 26 is preferably calculated at three or more predetermined cross-sectional planes, and the average value thereof is calculated.

In addition, in a cross-sectional plane parallel to the lamination direction of the inner ceramic layer 8 and the internal electrode layers 4 and 6, the average value of the thickness (Tm) of the intermediate layer 24 (26) is preferably 0.10 μm or more and 5.00 μm or less, and more preferably 0.10 μm or more and 2.00 μm or less.

The thickness (Tm) of the intermediate layer 24 (26) is preferably measured at three or more locations, and an average value is calculated.

In addition, in the above-described predetermined cross-sectional plane, Sm/Sin is 0.04 or more and 0.85 or less. Here, Sm is the sum of the areas of the intermediate layers 24 and 26 in the region in which the internal electrode layers 4 and 6 face each other, and Sin is the sum of the areas of the internal electrode layers 4 and 6 in the region in which the internal electrode layers 4 and 6 face each other.

A method for identifying the intermediate layers 24 and 26 is not particularly limited, but for example, when a line analysis is performed from the inner ceramic layer 8 to the internal electrode layer 4 (6), the intermediate layer 24 (26) can be identified as a region in which the ratio of the elements constituting the intermediate layer 24 (26) is the highest among regions in which the peak of the elements constituting the intermediate layer 24 (26) overlaps the peak of the elements constituting the internal electrode layer 4 (6), or regions in which the peak of the elements constituting the intermediate layer 24 (26) is adjacent thereto.

Therefore, when the peak of zinc oxide exists between the peak of the elements constituting the intermediate layer 24 (26) and the peak of the elements constituting the internal electrode layer 4 (6), it is not determined that the peak of the elements constituting the intermediate layer 24 (26) is adjacent to the peak of the elements constituting the internal electrode layer 4 (6).

In addition, the intermediate layer 24 (26) may be identified from an image obtained by elemental mapping using an energy dispersive X-ray spectrometer (EDS) or the like.

Elemental analysis can be performed by a combination of a scanning electron microscope (SEM) and EDS (SEM-EDS), a combination of a scanning transmission electron microscopy (STEM) and EDS (STEM-EDS), inductively coupled plasma mass spectrometry (ICP-MS), laser ablation inductively coupled plasma mass spectrometry (LA-ICP-MS), or the like.

### Method for Manufacturing Multilayer Chip Varistor

Next, one example of a method for manufacturing the multilayer chip varistor 2 according to the present embodiment will be described.

In the present embodiment, a green chip is produced by a typical screen printing method using a paste, and after the green chip is fired, the external terminal electrodes 12 and 14 are printed or transferred and fired, thereby manufacturing the multilayer chip varistor 2. Hereinafter, the manufacturing method will be specifically described.

First, a ceramic layer paste, an internal electrode layer paste, an intermediate layer paste, and an external terminal electrode paste are respectively prepared.

A voltage nonlinear resistor raw material is prepared and made into a coating material to formulate a ceramic layer paste.

The ceramic layer paste may be an organic-based coating material obtained by kneading the voltage nonlinear resistor raw material and an organic vehicle, or may be a water-based coating material.

As the voltage nonlinear resistor raw material, oxides, mixtures, or composite oxides of the main component and subcomponents of the inner ceramic layer 8 can be used; however, various compounds that are converted into the above-described oxides or composite oxides by firing, for example, carbonates, oxalates, nitrates, hydroxides, organometallic compounds, and the like can also be appropriately selected, mixed, and used.

The amount of each component in the voltage nonlinear resistor raw material may be determined so as to obtain the above-described composition of the inner ceramic layer 8 after firing. Typically, raw material powders having an average particle size of about 0.3 μm to 2 μm are used as these raw material powders.

The organic vehicle is obtained by dissolving a binder in an organic solvent. The binder used in the organic vehicle is not particularly limited and may be appropriately selected from various typical binders such as ethyl cellulose and polyvinyl butyral. The organic solvent to be used is also not particularly limited and may be appropriately selected from various organic solvents such as terpineol, butyl carbitol, acetone, and toluene, depending on the method to be used, such as a printing method or a sheet method.

In addition, when the ceramic layer paste is a water-based coating material, a water-based vehicle in which a water-soluble binder, a dispersant, or the like is dissolved in water may be kneaded with the voltage nonlinear resistor raw material. The water-soluble binder is not particularly limited, and for example, polyvinyl alcohol, cellulose, a water-soluble acrylic resin, or the like may be used.

The internal electrode layer paste is formulated by kneading various conductive materials described above, or various oxides, organometallic compounds, resinates, or the like that are converted into the above-described conductive materials after firing, with the above-described organic vehicle. In addition, the external terminal electrode paste may also be formulated in the same manner as the internal electrode layer paste.

The intermediate layer paste is formulated by kneading the above-described components contained in the intermediate layers 24 and 26, or various oxides that are converted into the above-described components after firing, with the above-described organic vehicle.

The amount of the organic vehicle in each of the above-described pastes is not particularly limited, and for example, the typical amount of the binder may be about 1% by mass to 5% by mass, and the typical amount of the solvent may be about 10% by mass to 50% by mass. In addition, each paste may contain, as necessary, additives selected from various dispersants, plasticizers, dielectrics, insulators, and the like. The total amount thereof is preferably 10% by mass or less.

Next, a green chip is manufactured. The green chip may be manufactured by a sheet lamination method or a sheet printing method.

The sheet lamination method is performed according to the following procedure.

A green sheet is formed using the ceramic layer paste, and thereafter, a predetermined number of the green sheets are laminated to form the green outer protective layer 8a.

Next, the internal electrode layer paste is printed in a predetermined pattern on the outer protective layer 8a to form the green internal electrode layer 4.

Next, the intermediate layer paste is printed in a predetermined pattern on the internal electrode layer 4 to form the green intermediate layer 24.

The above-described predetermined pattern may be controlled by a mask.

Furthermore, a predetermined number of the green sheets are laminated on the green intermediate layer 24 to form the green inner ceramic layer 8.

Next, the intermediate layer paste is printed in a predetermined pattern on the inner ceramic layer 8 to form the green intermediate layer 26.

Furthermore, the internal electrode layer paste is printed in a predetermined pattern on the green intermediate layer 26 to form the green internal electrode layer 6. The internal electrode layers 4 and 6 are printed so as to face each other and be exposed at different end surfaces.

Finally, a predetermined number of the green sheets are laminated on the internal electrode layer 6 in the same manner as described above to form the green outer protective layer 8a. Thereafter, the resultant is pressurized and pressure-bonded under heating, cut into a predetermined shape, and then peeled off from a substrate to obtain a green chip.

The sheet printing method is performed according to the following procedure.

The ceramic layer paste is printed a plurality of times to a predetermined thickness on a substrate such as PET to form the green outer protective layer 8a.

Next, the internal electrode layer paste is printed in a predetermined pattern on the outer protective layer 8a to form the green internal electrode layer 4.

Next, the intermediate layer paste is printed in a predetermined pattern on the internal electrode layer 4 to form the green intermediate layer 24.

The above-described predetermined pattern may be controlled by a mask.

Furthermore, the ceramic layer paste is printed a plurality of times to a predetermined thickness on the green intermediate layer 24 in the same manner as described above to form the green inner ceramic layer 8.

Next, the intermediate layer paste is printed in a predetermined pattern on the inner ceramic layer 8 to form the green intermediate layer 26.

Furthermore, the internal electrode layer paste is printed in a predetermined pattern on the green intermediate layer 26 to form the green internal electrode layer 6. The internal electrode layers 4 and 6 are printed so as to face each other and be exposed at different end surfaces.

Finally, the ceramic layer paste is printed a plurality of times to a predetermined thickness on the internal electrode layer 6 in the same manner as described above to form the green outer protective layer 8a. Thereafter, the resultant is pressurized and pressure-bonded under heating, cut into a predetermined shape, and then peeled off from a substrate to obtain a green chip.

The green chip obtained by any of the above-described methods is subjected to a binder removal treatment and firing to produce a sintered body (element body 10).

The binder removal treatment of the green chip may be performed under typical conditions. For example, in an air atmosphere, the heating rate is set to about 5 °C/hour to 300 °C/hour, the retention temperature is set to about 180 °C to 400 °C, and the temperature retention time is set to about 0.5 hours to 24 hours.

The firing of the green chip may be performed under typical conditions. For example, in an air atmosphere, the heating rate is set to about 50 °C/hour to 500 °C/hour, the retention temperature is set to about 800 °C to 1400 °C, the temperature retention time is set to about 0.5 hours to 8 hours, and the cooling rate is set to about 50 °C/hour to 500 °C/hour. Densification of the green chip is sufficiently and easily promoted by setting the retention temperature to about 800 °C or higher. Abnormal sintering of the internal electrode layers 4 and 6 and disconnection of the electrodes are easily prevented by setting the retention temperature to about 1400 °C or lower.

The sintered body (element body 10) obtained as described above is subjected to end face polishing, for example, by barrel polishing or sandblasting, and the external terminal electrode paste is applied and fired to form the external terminal electrodes 12 and 14. The firing conditions for the external terminal electrode paste are preferably, for example, about 600 °C to 800 °C in an air atmosphere for about 10 minutes to 1 hour.

The multilayer chip varistor 2 of the present embodiment manufactured in this manner is connected to, for example, a high-speed transmission circuit or the like, and is used to protect the circuit or the like by absorbing or removing an external surge (abnormal voltage) such as static electricity, noise, or the like.

As a result of intensive studies, the present inventors have found that Pr and/or Bi are selected as elements constituting the intermediate layers 24 and 26.

The components of the internal electrode layers 4 and 6 tend to diffuse along grain boundaries of the inner ceramic layer 8 containing ZnO. Therefore, the diffusion rate of the components of the internal electrode layers 4 and 6 at the grain boundaries is reduced by forming a barrier at the grain boundaries with Pr and/or Bi other than ZnO, so that inhibition of the diffusion is facilitated. As a result, the diffusion of the components of the internal electrode layers 4 and 6 can be prevented during heat treatment. Accordingly, the inner ceramic layer 8 locally containing a large amount of the components constituting the internal electrode layers 4 and 6 is less likely to be formed in the vicinity of the internal electrode layers 4 and 6, and therefore, the degradation rate of the varistor voltage before and after application of ESD (ESD resistance degradation rate) can be reduced.

In particular, since the intermediate layers 24 and 26 in which Pr and/or Bi exist become an amorphous state such as a liquid phase during heat treatment, gaps such as voids (pores) tend to decrease. In particular, since the internal electrode layers 4 and 6 and the inner ceramic layer 8 typically have different thermal shrinkage rates, delamination may occur at the interfaces between the internal electrode layers 4 and 6 and the inner ceramic layer 8; however, in the present embodiment, since the intermediate layers 24 and 26 containing Pr and/or Bi become an amorphous state such as a liquid phase during heat treatment, the intermediate layers 24 and 26 improves bonding between the internal electrode layers 4 and 6 and the inner ceramic layer 8, so that delamination can be prevented.

When delamination (voids) occurs between the internal electrode layers 4 and 6 and the inner ceramic layer 8, that is, when the internal electrode layers 4 and 6 and the inner ceramic layer 8 are not in contact with each other, the multilayer chip varistor 2 may fail to function in the first place, and electrostatic discharge may also occur at locations of delamination, which may cause degradation of the multilayer chip varistor 2.

In contrast, in the present embodiment, as described above, since the predetermined intermediate layers 24 and 26 are provided between the internal electrode layers 4 and 6 and the inner ceramic layer 8, the generation of delamination between the internal electrode layers 4 and 6 and the inner ceramic layer 8 can be suppressed, and as a result, the multilayer chip varistor 2 can exhibit its functions, and degradation of the multilayer chip varistor 2 can also be prevented.

Furthermore, delamination can be further prevented, and as a result, the ESD resistance degradation rate can be further reduced by setting the coverage ratio of the intermediate layers 24 and 26 to 0.02 or more and 0.92 or less.

The embodiment of the present invention has been described above; however, the present invention is not limited to such an embodiment in any way and can be implemented in various modes without departing from the concept of the present invention.

For example, in the above description, the intermediate layers 24 and 26 are formed by a screen printing method, but can also be formed by a thin film method. Examples of the thin film method include a plating method, vapor deposition, sputtering, and the like.

When the intermediate layers 24 and 26 are formed by a sputtering method, sputtering is performed using a target for forming the intermediate layers 24 and 26.

As conditions for sputtering, the ultimate vacuum is preferably 10-2 Pa or less, and more preferably 10-3 Pa or less; the argon (Ar) gas introduction pressure is preferably 0.1 Pa to 2 Pa, and more preferably 0.3 Pa to 0.8 Pa; the output is preferably 50 W to 400 W, and more preferably 100 W to 300 W; and the sputtering temperature is preferably 20 °C to 150 °C, and more preferably 20 °C to 120 °C.

In addition, in the above-described embodiment, a multilayer chip varistor has been described as an example of the ceramic electronic device according to the present invention; however, the ceramic electronic device according to the present invention is not limited to a multilayer chip varistor, and may any device as long as the ceramic electronic device includes an inner ceramic layer, an internal electrode layer, and a predetermined intermediate layer.

In addition, as shown in FIG. 1, the multilayer chip varistor 2 is not limited to including only a pair of the internal electrode layers 4 and 6. In FIG. 1, only a pair of the internal electrode layers 4 and 6 are provided, but the multilayer chip varistor may be configured such that a plurality of pairs of internal electrode layers are laminated.

For example, since the multilayer chip varistor 2 according to the above-described embodiment includes only the pair of internal electrode layers 4 and 6, the “predetermined cross-sectional plane for calculating a coverage ratio and the like” is a cross-sectional plane including at least the pair of internal electrode layers 4 and 6. Therefore, in the predetermined cross-sectional plane, the outer protective layers 8a are shown at both ends in the lamination direction; however, when two or more pairs of internal electrode layers are laminated, in the predetermined cross-sectional plane, outer protective layers and/or an inner ceramic layer are shown at both ends in the lamination direction.

### EXAMPLES

Hereinafter, the present invention will be described in further detail based on examples; however, the present invention is not limited to these examples.

### Sample No. 1

First, raw materials for Zn, Co, Pr, Cr, Ca, K, Si, and Al were prepared. ZnO was prepared as the raw material for Zn. As the raw materials for Co, Pr, Cr, Ca, K, Si, and Al, oxides of the respective elements or compounds that were converted into oxides of the respective elements after firing were appropriately selected and prepared. Specific examples of the compounds that are converted into oxides of the respective elements after firing include carbonates, hydrates of carbonates, and the like.

Next, these raw materials were blended such that the composition of the inner ceramic layer 8 after firing became the following composition relative to 100 parts by mole of Zn, thereby obtaining a voltage nonlinear resistor raw material.

The amount of ZnO was set to 94 parts by mass when the total amount of materials constituting the inner ceramic layer 8 was taken as 100 parts by mass.

The amount of each component was set as follows when the amount of elements other than carbon, oxygen, and nitrogen contained in the inner ceramic layer 8 was taken as 100 at %.
Co: 1.50 at %
Pr: 0.50 at %
Cr: 0.10 at %
Ca: 2.00 at %
K: 0.05 at %
Si: 0.05 at %
Al: 0.005 at %

The voltage-nonlinear resistor raw material, an organic binder, an organic solvent, and a plasticizer were added together and wet-mixed using a ball mill for approximately 20 hours to produce a ceramic layer paste.

The ceramic layer paste was applied onto a PET film by a doctor blade method a plurality of times to a thickness of 11 μm to produce the green outer protective layer 8a.

An internal electrode layer paste was printed on the green outer protective layer 8a by screen printing so as to have a desired shape, and was dried to form the green internal electrode layer 4. The internal electrode layer paste was manufactured by wet-mixing the organic binder and the organic solvent described above with an oxide of Ag.

Next, an intermediate layer paste was printed on the green internal electrode layer 4 by screen printing so as to have a desired pattern, and was dried to form the intermediate layer 24 shown in FIG. 2. The intermediate layer paste was produced by wet-mixing the organic binder and the organic solvent described above with oxides of Pr, Co, Cr, Ca, and Si.

Furthermore, the ceramic layer paste was applied a plurality of times to form the green inner ceramic layer 8. Next, the green intermediate layer 26, the green internal electrode layer 6, and the green outer protective layer 8a were formed in the same manner as described above to form a green laminate.

The green laminate was heated and pressure-bonded, and then cut into a predetermined chip shape to form a green chip.

The green chip was subjected to a binder removal treatment under conditions of 350 °C for 2 hours, and was then fired in air at 900 °C for 2 hours to obtain a sintered body serving as the element body 10.

Next, silver paste was applied to both ends of the obtained sintered body and was fired at 800 °C to form the external terminal electrodes 12 and 14, thereby obtaining the multilayer chip varistor 2 (varistor sample) having the cross-sectional configuration shown in FIG. 1. The silver paste was manufactured by wet-mixing the organic binder and the organic solvent described above with an oxide of silver.

The specifications of the varistor sample, the delamination rate, the diffusion rate of the components of the internal electrode layers 4 and 6, and the ESD resistance were measured using the obtained varistor sample 2.

First, the size of the varistor sample 2 was 0.6 mm×0.3 mm×0.3 mm.

Next, a cross-sectional plane for measurement of the varistor sample 2 was obtained by the following method.

First, the varistor sample 2 was embedded and fixed in a resin, and was polished such that a cross-section in the lamination direction of the inner ceramic layer 8 and internal electrode layers 4 and 6, the cross-section including at least a pair of the internal electrode layers 4 and 6, was exposed, thereby obtaining a cross-sectional plane.

Next, this cross-sectional plane was observed by SEM (JSM-6510LA, manufactured by JEOL Ltd.), and an SEM image was captured at a magnification of 4000×. Image processing was performed on the SEM image using software (Analysis Station, manufactured by JEOL Ltd.) to obtain a measurement image. Next, the inner ceramic layer 8, the internal electrode layers 4 and 6, and the intermediate layers 24 and 26 were identified from an image obtained by elemental mapping the measurement image using EDS.

Measurement results obtained from the measurement image and the elemental mapping image are shown below.
Average value of thickness of the inner ceramic layer 8: 7 μm
Number of the inner ceramic layers 8 sandwiched between the internal electrode layers 4 and 6: 3
Average value of thickness (Tm) of the intermediate layers 24 and 26: 2 μm
Average value of coverage ratio of the intermediate layers 24 and 26: 0.10

### Composition of Intermediate Layer

The amount of each element in the intermediate layers 24 and 26 of the above-described cross-sectional plane was measured by LA-ICP-MS; when the amount of elements other than carbon, oxygen, and nitrogen contained in the intermediate layers 24 and 26 was taken as 100 parts by mole, the composition of the elements contained in the intermediate layers 24 and 26 was as follows.
Pr: 64 parts by mole
Co: 6 parts by mole
Cr: 8 parts by mole
Ca: 13 parts by mole
Si: 0.05 parts by mole

### Delamination Rate

The delamination rate is the porosity at the interfaces between the internal electrode layers 4 and 6 and the inner ceramic layer 8 or the intermediate layers 24 and 26. Specifically, the delamination rate (porosity) was calculated using the measurement image and the elemental mapping image according to the following equation: 100×Ls/(N×L) [%].

Here, L is the length, in the layer direction, of the region in which the internal electrode layers 4 and 6 face each other. In addition, Ls is the value of the sum of the lengths, in the layer direction, of regions in which the voids 18 are formed at the interfaces between the internal electrode layers 4 and 6 and the inner ceramic layer 8 or the interfaces between the internal electrode layers 4 and 6 and the intermediate layers 24 and 26.

For example, since the lengths, in the layer direction, of the voids 18 formed at the interfaces between the internal electrode layers 4 and 6 and the inner ceramic layer 8 or the interfaces between the internal electrode layers 4 and 6 and the intermediate layers 24 and 26 in the region in which the internal electrode layers 4 and 6 face each other are shown as “Ls1” and “Ls2” in FIG. 2, the equation Ls=Ls1+Ls2 is established.

N is the number of surfaces of the internal electrode layer 4 (6) with which the intermediate layer 24 (26) is in contact at at least one location.

The porosity was calculated at three predetermined cross-sectional planes, and evaluation were made as follows based on the average value thereof. The results are shown in Table 1B.
A: Less than 3%
B: 3% or more and less than 5%
C: 5% or more

### Diffusion Rate of Components of Internal Electrode Layer

The amount of the components of the internal electrode layers 4 and 6 in the inner ceramic layer 8 of the above-described cross-sectional plane was measured by LA-ICP-MS, with Zn taken as 100 parts by mole. The amount of the components of the internal electrode layers 4 and 6 in the inner ceramic layer 8 was evaluated as the diffusion rate of the components of the internal electrode layers 4 and 6. In addition, evaluations were made as follows based on the diffusion rate of the components of the internal electrode layers 4 and 6. The results are shown in Table 1B. In Sample No. 1, the “component of the internal electrode layers 4 and 6” is Ag.
A: Less than 0.1 parts by mole
B: 0.1 parts by mole or more and less than 0.8 parts by mole
C: 0.8 parts by mole or more and less than 1.5 parts by mole
D: 1.5 parts by mole or more and 5.2 parts by mole or less

### ESD Resistance Degradation Rate

First, the varistor sample 2 was connected to a DC constant voltage power supply, and when a current flowing through the varistor sample 2 was 1 mA, the voltage acting between the electrodes of the varistor sample 2 was read using a voltmeter, and the value was taken as a pre-test varistor voltage (V1mA_before) (unit: V).

Next, an electrostatic discharge immunity test specified in the IEC 61000-4-2 standard of the International Electrotechnical Commission (IEC) was performed on the varistor sample 2, and a varistor voltage was obtained for the varistor sample 2 after the test in the same manner as described above and was taken as a post-test varistor voltage (V1 mA_after) (unit: V).

The conditions for the electrostatic discharge immunity test were as follows.

Using a capacitor-type electrostatic simulator having a charging capacity of 150 pF and a discharge resistance of 330Ω, a predetermined ESD voltage stored in the electrostatic simulator was applied by contact discharge to the varistor sample 2 mounted on an evaluation substrate. The applied voltage was 25 kV and was applied 10 times in a positive (+) direction and 10 times in a negative (−) direction at intervals of 0.1 seconds.

The ESD resistance degradation rate was obtained according to the following equation.

100×{1−(V1 mA_after)/(V1 mA_before)} [%]

Evaluations were made as follows based on the ESD resistance degradation rate. The results are shown in Table 1B.
A: 2% or less
B: More than 2% and 5% or less
C: More than 5% and 7% or less
D: More than 7% and 10% or less
E: More than 10%

The results shows that the lower the ESD resistance degradation rate is, the better the ESD resistance characteristics are.

### Sample Nos. 2-15, 18, 19, 22-28, 30, 5a, 18a, 18b, 22a, 22b, 24a, 24b, 24c, 24d, 24e

The varistor samples 2 were produced and evaluated in the same manner as Sample No. 1, except that the components of the internal electrode layers 4 and 6, the average value of the thickness (Tm) of the intermediate layers 24 and 26, the coverage ratio of the intermediate layers 24 and 26, and the constituent elements of the intermediate layers 24 and 26 were set as shown in Table 1A or Table 2A. The results are shown in Table 1A, Table 1B, Table 2A, and Table 2B.

### Sample Nos. 16, 17, 20, 21, 29, 16a, 16b, 20a, 20b

In Sample Nos. 16, 17, 20, 21, 29, 16a, 16b, 20a, 20b, the varistor samples 2 were produced and evaluated in the same manner as Sample No. 1, except that the internal electrode layers 4 and 6 and the intermediate layers 24 and 26 were formed by the thin film method described in the above-described embodiment, and that the components of the internal electrode layers 4 and 6, the average value of the thickness (Tm) of the intermediate layers 24 and 26, the coverage ratio of the intermediate layers 24 and 26, and the constituent elements of the intermediate layers 24 and 26 were set as shown in Table 1A or Table 2A. The results are shown in Table 1A, Table 1B, Table 2A, and Table 2B.

### Sample No. 35

In Sample No. 35, a varistor sample was produced and evaluated in the same manner as Sample No. 1, except that intermediate layers 24 and 26 were not formed. The results are shown in Table 2A and Table 2B.

TABLE 1A

| | | | | | Main | |
|---|---|---|---|---|---|---|
| | | Components of | Thickness of | Coverage | Component | |
| | | Internal | Intermediate | Ratio of | Elements of | Elements Other Than Main |
| Sample | Intermediate Layer | Electrode | Layer | Intermediate | Internal | Components of Internal |
| No. | Forming Method | Layer | [μm] | Layer | Electrode Layer | Electrode Layer |
| 1 | screen printing method | Ag | 2.00 | 0.10 | Pr | Co, Cr, Ca, Si |
| 2 | screen printing method | Ag/Pd = 9/1 | 2.00 | 0.10 | Pr | Co, Cr, Ca, Si |
| 3 | screen printing method | Ag/Pd = 1/9 | 2.00 | 0.10 | Pr | Co, Cr, Ca, Si |
| 4 | screen printing method | Pd | 2.00 | 0.10 | Pr | Co, Cr, Ca, Si |
| 5 | screen printing method | Ag/Pd = 9/1 | 2.00 | 0.10 | Pr | Co, Cr, Ca |
| 5a | screen printing method | Ag/Pd = 9/1 | 2.00 | 0.80 | Pr | Co, Cr, Ca, Si |
| 6 | screen printing method | Ag/Pd = 9/1 | 2.00 | 0.50 | Pr | Co, Cr, Ca, Si |
| 7 | screen printing method | Ag/Pd = 9/1 | 2.00 | 0.30 | Pr | Co, Cr, Ca, Si |
| 8 | screen printing method | Ag/Pd = 9/1 | 2.00 | 0.10 | Pr | Co, Cr |
| 9 | screen printing method | Ag/Pd = 9/1 | 2.00 | 0.50 | Pr | Co, Cr |
| 10 | screen printing method | Ag/Pd = 9/1 | 2.00 | 0.10 | Pr | Co, Ca |
| 11 | screen printing method | Ag/Pd = 9/1 | 2.00 | 0.50 | Pr | Co, Ca |
| 12 | screen printing method | Ag/Pd = 9/1 | 2.00 | 0.10 | Pr | Co, Si |
| 13 | screen printing method | Ag/Pd = 9/1 | 2.00 | 0.50 | Pr | Co, Si |
| 14 | screen printing method | Ag/Pd = 9/1 | 2.00 | 0.10 | Pr | Co |
| 15 | screen printing method | Ag/Pd = 9/1 | 2.00 | 0.50 | Pr | Co |
| 16 | thin film method | Ag/Pd = 9/1 | 0.10 | 0.02 | Pr | Co |
| 16a | thin film method | Ag/Pd = 9/1 | 0.10 | 0.05 | Pr | Co |
| 16b | thin film method | Ag/Pd = 9/1 | 0.10 | 0.90 | Pr | Co |
| 17 | thin film method | Ag/Pd = 9/1 | 0.10 | 0.92 | Pr | Co |
| 18 | screen printing method | Ag/Pd = 9/1 | 5.00 | 0.02 | Pr | Co |
| 18a | screen printing method | Ag/Pd = 9/1 | 5.00 | 0.05 | Pr | Co |
| 18b | screen printing method | Ag/Pd = 9/1 | 5.00 | 0.90 | Pr | Co |
| 19 | screen printing method | Ag/Pd = 9/1 | 5.00 | 0.92 | Pr | Co |

TABLE 1B

| | | | Diffusion Rate of | | | | |
|---|---|---|---|---|---|---|---|
| | | | Components of | ESD Resistance | | | |
| Sample | Delamination Rate | | Internal Electrode | Degradation Rate | | V1mA_before | V1mA_after |
| No. | [%] | Effect | Layer | [%] | Effect | [V] | [V] |
| 1 | 0.5 | A | A | 0.19 | A | 26.99 | 26.94 |
| 2 | 1.3 | A | A | 0.11 | A | 27 | 26.97 |
| 3 | 0.4 | A | A | 0.15 | A | 26.96 | 26.92 |
| 4 | 1.4 | A | A | 0.18 | A | 27.03 | 26.98 |
| 5 | 0.8 | A | A | 0.41 | A | 27.01 | 26.90 |
| 5a | 3.1 | B | A | 1.73 | A | 27.13 | 26.66 |
| 6 | 2.9 | A | A | 1.69 | A | 27.28 | 26.82 |
| 7 | 0.4 | A | A | 1.21 | A | 27.21 | 26.88 |
| 8 | 0.7 | A | B | 4.67 | B | 27.17 | 25.90 |
| 9 | 0.3 | A | B | 3.43 | B | 27.10 | 26.17 |
| 10 | 1.9 | A | C | 5.10 | C | 26.88 | 25.51 |
| 11 | 1.8 | A | C | 5.39 | C | 26.88 | 25.43 |
| 12 | 0.6 | A | C | 6.49 | C | 26.83 | 25.09 |
| 13 | 1.4 | A | C | 6.54 | C | 27.23 | 25.45 |
| 14 | 1.7 | A | C | 6.68 | C | 27.10 | 25.29 |
| 15 | 1.2 | A | C | 6.78 | C | 27.15 | 25.31 |
| 16 | 1.1 | A | D | 6.49 | C | 27.11 | 25.35 |
| 16a | 1.1 | A | D | 6.81 | C | 27.02 | 25.18 |
| 16b | 3.0 | B | C | 6.61 | C | 27.10 | 25.31 |
| 17 | 3.0 | B | C | 6.59 | C | 26.87 | 25.10 |
| 18 | 0.3 | A | D | 6.23 | C | 26.95 | 25.27 |
| 18a | 0.4 | A | D | 6.30 | C | 26.99 | 25.29 |
| 18b | 4.8 | B | C | 6.22 | C | 27.02 | 25.34 |
| 19 | 4.9 | B | C | 6.00 | C | 26.98 | 25.36 |

TABLE 2A

| | | | | | Main | |
|---|---|---|---|---|---|---|
| | | Components of | Thickness of | Coverage | Component | |
| | | Internal | Intermediate | Ratio of | Elements of | Elements Other Than Main |
| Sample | Intermediate Layer | Electrode | Layer | Intermediate | Internal | Components of Internal |
| No. | Forming Method | Layer | [μm] | Layer | Electrode Layer | Electrode Layer |
| 20 | thin film method | Ag/Pd = 9/1 | 0.10 | 0.02 | Pr | — |
| 20a | thin film method | Ag/Pd = 9/1 | 0.10 | 0.05 | Pr | — |
| 20b | thin film method | Ag/Pd = 9/1 | 0.10 | 0.90 | Pr | — |
| 21 | thin film method | Ag/Pd = 9/1 | 0.10 | 0.92 | Pr | — |
| 22 | screen printing method | Ag/Pd = 9/1 | 5.00 | 0.02 | Pr | — |
| 22a | screen printing method | Ag/Pd = 9/1 | 5.00 | 0.05 | Pr | — |
| 22b | screen printing method | Ag/Pd = 9/1 | 5.00 | 0.90 | Pr | — |
| 23 | screen printing method | Ag/Pd = 9/1 | 5.00 | 0.92 | Pr | — |
| 24 | screen printing method | Ag/Pd = 9/1 | 2.00 | 0.10 | Bi | — |
| 24a | screen printing method | Ag/Pd = 9/1 | 2.00 | 0.10 | Pr | — |
| 24b | screen printing method | Ag/Pd = 5/5 | 2.00 | 0.10 | Pr | |
| 24c | screen printing method | Ag/Pd = 1/9 | 2.00 | 0.10 | Pr | — |
| 24d | screen printing method | Ag | 2.00 | 0.10 | Pr | — |
| 24e | screen printing method | Pd | 2.00 | 0.10 | Pr | — |
| 25 | screen printing method | Cu | 2.00 | 0.10 | Pr | — |
| 26 | screen printing method | Ni | 2.00 | 0.10 | Pr | — |
| 27 | screen printing method | Pt | 2.00 | 0.10 | Pr | — |
| 28 | screen printing method | Ag/Pd = 9/1 | 6.00 | 0.92 | Pr | — |
| 29 | thin film method | Ag/Pd = 9/1 | 0.09 | 0.92 | Pr | — |
| 30 | screen printing method | Ag | 6.00 | 1.00 | Pr | — |
| 35 | — | Pt | 0 | 0 | — | — |

TABLE 2B

| | | | Diffusion Rate of | | | | |
|---|---|---|---|---|---|---|---|
| | | | Components of | ESD Resistance | | | |
| Sample | Delamination Rate | | Internal Electrode | Degradation Rate | | V1mA_before | V1mA_after |
| No. | [%] | Effect | Layer | [%] | Effect | [V] | [V] |
| 20 | 1.8 | A | D | 7.23 | D | 27.10 | 25.14 |
| 20a | 1.7 | A | D | 7.41 | D | 27.27 | 25.25 |
| 20b | 3.9 | B | C | 7.32 | D | 27.05 | 25.07 |
| 21 | 3.9 | B | C | 7.06 | D | 26.91 | 25.01 |
| 22 | 0.7 | A | D | 7.79 | D | 27.10 | 24.99 |
| 22a | 0.9 | A | D | 7.44 | D | 27.00 | 24.99 |
| 22b | 3.3 | B | C | 8.09 | D | 26.96 | 24.78 |
| 23 | 3.5 | B | C | 7.47 | D | 26.89 | 24.88 |
| 24 | 1.5 | A | C | 8.19 | D | 27.23 | 25.00 |
| 24a | 0.9 | A | C | 7.92 | D | 26.90 | 24.77 |
| 24b | 1.3 | A | C | 7.45 | D | 26.99 | 24.98 |
| 24c | 1.3 | A | C | 7.98 | D | 27.08 | 24.92 |
| 24d | 1.4 | A | C | 7.70 | D | 27.03 | 24.95 |
| 24e | 1.6 | A | C | 7.52 | D | 27.25 | 25.20 |
| 25 | 1.8 | A | C | 7.58 | D | 27.04 | 24.99 |
| 26 | 1.8 | A | C | 7.77 | D | 27.04 | 24.94 |
| 27 | 1.6 | A | C | 7.88 | D | 27.03 | 24.90 |
| 28 | 4.0 | B | C | 9.45 | D | 27.20 | 24.63 |
| 29 | 3.1 | B | C | 9.10 | D | 27.02 | 24.56 |
| 30 | 7.9 | C | C | 9.83 | D | 26.95 | 24.3 |
| 35 | 1.4 | A | E | 12.73 | E | 26.95 | 23.52 |

From Table 1A, Table 1B, Table 2A, and Table 2B, it was confirmed that, in cases in which the intermediate layers 24 and 26 were provided (Sample Nos. 1 to 30, 5a, 16a, 16b, 18a, 18b, 20a, 20b, 22a, 22b, 24a, 24b, 24c, 24d, and 24e), the diffusion rate of the components of the internal electrode layers 4 and 6 was lower and the ESD resistance degradation rate was lower compared to a case in which the intermediate layers 24 and 26 were not provided (Sample No. 35).

### EXPLANATIONS OF LETTERS OR NUMERALS

2 MULTILAYER CHIP VARISTOR, VARISTOR SAMPLE
4, 6 INTERNAL ELECTRODE LAYER
8 INNER CERAMIC LAYER, INTERLAYER VOLTAGE NONLINEAR RESISTIVE LAYER, VARISTOR LAYER
8a OUTER PROTECTIVE LAYER
10 ELEMENT BODY
12, 14 EXTERNAL TERMINAL ELECTRODE
24, 26 INTERMEDIATE LAYER

1. A ceramic electronic device comprising:
an inner ceramic layer;
at least a pair of internal electrode layers disposed so as to sandwich the inner ceramic layer between the pair of internal electrode layers; and
intermediate layers provided between the inner ceramic layer and the internal electrode layers,
wherein the intermediate layers contain, as a main component or main components, at least one element selected from the group consisting of praseodymium and bismuth.

2. The ceramic electronic device according to claim 1,
wherein the intermediate layers further contain zinc as the main component,
wherein the main components of the intermediate layers are components each having a total amount of 10 at % or more when the total amount of elements other than oxygen, carbon, and nitrogen contained in the intermediate layers is taken as 100 at %, and
wherein a total amount of the at least one element selected from the group consisting of praseodymium and bismuth contained in the intermediate layers is 10 at % or more when the total amount of elements other than oxygen, carbon, and nitrogen contained in the intermediate layers is taken as 100 at %.

3. The ceramic electronic device according to claim 1,
wherein a coverage ratio of the intermediate layers is 0.02 or more and 0.92 or less, in a predetermined cross-sectional plane parallel to a lamination direction of the inner ceramic layer and the internal electrode layers,
the coverage ratio of the intermediate layers is represented by Lm/(L×N),
where
L is a length, in a layer direction, of a region in which the internal electrode layers face each other,
Lm is a total length, in the layer direction, of regions in which the internal electrode layers and the intermediate layers are in contact with each other within the region in which the internal electrode layers face each other, and
N is the number of surfaces of the internal electrode layers that are in contact with the intermediate layers at least one location.

4. The ceramic electronic device according to claim 1,
wherein an average value of a thickness of the intermediate layer is 0.10 μm or more and 5.00 μm or less in a cross-sectional plane parallel to a lamination direction of the inner ceramic layer and the internal electrode layers.

5. The ceramic electronic device according to claim 1,
wherein the intermediate layers further contain cobalt.

6. The ceramic electronic device according to claim 5,
wherein the intermediate layers further contain chromium.

7. The ceramic electronic device according to claim 6,
wherein the intermediate layers further contain calcium.

8. The ceramic electronic device according to claim 1,
wherein the internal electrode layers contain at least one element selected from the group consisting of silver and palladium.

9. The ceramic electronic device according to claim 1,
wherein the inner ceramic layer is a varistor layer.
